(19) United States
(12) Patent Application Publication
(10) Pub. No.: US 2007/0263192 A1
(43) Pub. Date: Nov. 15, 2007

(54) Illumination system and a photolithography apparatus employing the system

(75) Inventors: Karsten Bubke, Dresden (DE); Martin Sczyrba, Dresden (DE)

Correspondence Address: MAYBACK & HOFFMAN, P.A., 5722 S. FLAMINGO ROAD #232, FORT LAUDERDALE, FL, 33330, US

(73) Assignee: Advanced Mask Technology Center GmbH & Co. KG

(21) Appl. No.: 11/803,199

(22) Filed: May 14, 2007

(30) Foreign Application Priority Data
May 15, 2006 (EP) 06 113 941.6

(51) Int. Cl. G03B 27/42

(52) U.S. Cl. 355/53; 355/67

(57) ABSTRACT

An illumination system includes a device for generating an illumination distribution, the illumination distribution having a center point and an outer edge. The illumination distribution includes a first opaque portion defined about the center point, a second opaque portion defined adjacent to the outer edge, and a radiation transmittant portion disposed between the first and the second opaque portions. The illumination system further includes a polarization device that generates a linearly polarized electromagnetic radiation having a locally varying polarization direction so that at least first and second polarization directions are generated. The first polarization direction is different from the second polarization direction and the polarization direction at at least two different points of the radiation transmittant portion of the illumination distribution is parallel to a line connecting that point and the center point of the illumination distribution. A photolithography apparatus employing the illumination system is also provided.

### CROSS-REFERENCE TO RELATED APPLICATION

This application claims the priority, under 35 U.S.C. §119, of copending European Application No. 06 113 941.6, filed May 5, 2006, which designated the United States and was not published in English; the prior application is herewith incorporated by reference herein in its entirety.

### BACKGROUND OF THE INVENTION

### Field of the Invention

The invention lies in the field of illumination systems. The present invention, in particular, relates to an illumination system suitable for use in a photolithography apparatus as well as to a photolithography apparatus including such an illumination system.

During the manufacture of a semiconductor device, components of the device usually are formed by patterning layers that are deposited on a silicon wafer. The patterning of these layers usually is accomplished by applying a resist material onto the layer, which resist has to be patterned, and by subsequently exposing predetermined portions of the resist layer that is sensitive to the exposure wavelength. Thereafter, the regions that have been irradiated with the radiation (or not) are developed and the irradiated or not irradiated portions are subsequently removed. As a consequence, portions of the layer are masked by the generated photoresist pattern during a following process step, such as an etching step or an implantation step. After processing the exposed portions of the underlying layer, the resist mask is removed.

A general task of present photolithography is to reach smaller pattern sizes as well as a greater admissible depth of focus (DOF) with constant exposure wavelength.

### SUMMARY OF THE INVENTION

It is accordingly an object of the invention to provide an illumination system and a photolithography apparatus employing the system that overcome the hereinafore-mentioned disadvantages of the heretofore-known devices of this general type and that provides, with novel masks, in particular, phase shifting masks, and, alternatively, with the use of off-axis illumination, an illumination system by which the image contrast and, thus, the image quality of a pattern transferred onto a substrate can be remarkably improved.

FIG. 1 illustrates an effect of off-axis illumination and schematically illustrates a view of an optical projection or photolithography apparatus 71 for imaging a pattern formed on a reticle 74 onto a substrate, for example, a semiconductor wafer to be patterned. An illumination source 721 emits electromagnetic radiation in a predetermined wavelength range. The optical projection apparatus further includes a condenser lens 722, a device for generating an illumination distribution 73 as well as the reticle 74. A pattern 741 is formed on the reticle 74. The pattern 741 of the reticle 74 is imaged by the projection system 711 onto the wafer 75. The illumination distribution generating device 73 can be formed so as to define an arbitrary illumination distribution in the illumination pupil plane of the optical projection apparatus 71. The illumination distribution generating device 73 can, for example, be an aperture element 73, as is indicated in FIG. 1. In the example, the aperture element 73 can be formed to provide an axial light beam 724 that impinges perpendicularly onto the reticle 74. In such a case, the aperture element, for example, has an opening in a center portion thereof and transmits 100% of the incoming radiation. Alternatively, the aperture element 73 can, as well, have openings located outside the center thereof, so that off-axis beams 725 are generated. When the on-axis beam 724 is diffracted by the pattern 741 on the reticle 74, depending on the structural feature sizes, only the 0-th order diffraction beam is located within the entrance pupil region 7111 of the projection system 711. However, if the off-axis beam 725 is diffracted by the pattern 741 of the reticle, the 0-th and −1^{st} diffraction order are located within the entrance pupil 7111 of the projection system 711. The diffraction orders of the off-axis beam 725 are denoted by broken lines, whereas the diffraction orders of the on-axis beam 724 are indicated by complete lines. Generally, the quality of the imaged pattern is better when more diffraction orders are located within the entrance pupil region 7111 of the lens assembly 711. Accordingly, as becomes clear from FIG. 1, using off-axis illumination, at least two interfering diffraction orders can be generated.

FIG. 2 shows as an example an interference pattern 712 that is formed by superposing the 0^{th} diffraction order and the +1^{st} diffraction order of the diffracted off-axis beam 725. The off-axis lumination can be used, for example, with chrome on glass (COG), halftone phase shifting masks (HTPSM), or chrome phase lithography (CPL) masks.

In the context of the present invention, a pole or illumination pole, refers to a portion of the illumination pupil region, the portion having a higher intensity of light than the remaining part of the illumination pupil portion surrounding the illumination pole.

An illumination distribution including one or more poles may be generated, for example, by using an appropriate aperture element, a diffractive element, or a suitable system of lenses.

Generally, in an alternating phase shifting mask (AltPSM), the transparent substrate of the mask itself is patterned to provide phase shifting regions. More specifically, adjacent transparent regions result in phases shifted by 180°. In addition, optionally, a chrome pattern may be formed on the mask surface. A characteristic feature of alternating phase shifting masks or chrome-less phase shifting masks is the low mask error enhancement factor (MEEF). For example, a low mask error enhancement factor results in defective structures in the masks having only few results on the defects of the image on the wafer. In addition, an increased depth of focus (DOF) and a higher resolution can be obtained with this mask type.

The lithographic working principle of AltPSM masks is fundamentally different from the off-axis schemes explained hereinabove. As can be seen, for example, from FIG. 3, on-axis illumination is used. In FIG. 3, the 0-th diffraction order is minimized and the 1^{st} and −1^{st} order are used for imaging dense lines and spaces. In other words, light emitted by a radiation source is diffracted by the pattern 741 on the AltPSM mask 74 to generate a +1^{st} and a −1^{st} diffraction order light beam 7132, 7131. The +1^{st} and −1^{st} diffraction order light beams 7132, 7131 interfere to generate an interference pattern 712. For generating an on-axis beam, an aperture element similar to the one shown in FIG. 4 can be used. As can be seen, the aperture element 73 includes a transparent portion 737 at a center thereof, while the aperture element has an opaque portion 738 adjacent to the edge portion. In particular, the illumination distribution generated by the aperture element 73 shown in FIG. 4 has a central pole in which the intensity is very high compared to the edges of the illumination distribution.

With the foregoing and other objects in view, there is provided, in accordance with the invention, a photolithography apparatus, including a reticle including at least one pattern extending in a first direction and having a pattern size dy, an optical projection system for projecting an image of the reticle onto a substrate to be patterned, the optical projection system having a numerical aperture, and an illumination system. The illumination system includes an illumination source emitting electromagnetic radiation, a polarization device, a device for generating an illumination distribution, the illumination distribution generated by the device having a center point and an outer edge. The illumination distribution comprises a first opaque portion defined about the center point, each point of the first opaque portion having a distance from the center point smaller than rᵢₙ, a second opaque portion defined adjacent to the outer edge, the second opaque portion having a distance from the center point which is larger than rₒᵤₜ, and a radiation transmittant portion disposed between the first and the second opaque portions. The polarization device is disposed between the illumination source and the device for generating an illumination distribution. The polarization device is adapted to generate linearly polarized electromagnetic radiation having a locally varying polarization direction so that at least first and second polarization directions are generated, the first polarization direction being different from the second polarization direction. A radius rₒᵤₜ of the second opaque portion being determined dependent upon the pattern size dy and the numerical aperture so that for a ±1^{st} diffraction order part of light due to illumination with the radiation transmittant portion lies outside the numerical aperture.

In accordance with another feature of the invention, sections of the radiation transmittant portion are parallel polarized such that, in the radiation transmittant portion, at least two points that are disposed along a direction perpendicular to the first polarization direction are polarized along the first polarization direction.

In accordance with another feature of the invention, sections of the radiation transmittant portion are radial polarized such that, in the radiation transmittant portion, each point is associated with a polarization parallel to a line connecting the respective point and the center point.

In accordance with another feature of the invention, for example, the radiation transmittant portion may include a first, a second, a third, and a fourth pole, wherein the first and the second poles are disposed along a first direction, and the third and fourth poles are disposed along a second direction, the second direction being perpendicular to the first direction. The intensity of transmitted radiation in each of the poles is larger than in another part of the radiation transmittant portion, the polarization direction of the electromagnetic radiation being transmitted by the first and second poles is parallel to the first direction, and the polarization direction of the electromagnetic radiation being transmitted by the third and fourth poles is parallel to the second direction.

In accordance with a further feature of the invention, by way of example, each of the poles can have a circular shape.

Alternatively, at least one of the poles can have an elliptical shape.

In accordance with an added feature of the invention, at least one of the poles can have the shape of a segment of a ring. For example, the ring may be formed by the contour of the radiation transmittant portion. The segments may be formed so that the borders of the segments, the borders intersecting the contour of the radiation transmittant portion, have a radial direction from the center point of the device for generating an illumination distribution.

In accordance with an additional feature of the invention, the diameter of each of the first, second, third and fourth poles may be equal to the difference between rₒᵤₜ and rᵢₙ.

Nevertheless, the diameter of each of the first, second, third, and fourth poles can be different from one other.

In accordance with yet a further feature of the invention, the radius rᵢₙ is constant.

In accordance with yet an added feature of the invention, the radius rₒᵤₜ is constant.

In accordance with yet an additional feature of the invention, a radius r_{in,y} measured in a first direction is different from a radius r_{in,x} measured in a second direction perpendicular to the first direction.

In accordance with again another feature of the invention, a radius r_{out,y} measured in a first direction is different from a radius r_{out,x} measured in a second direction perpendicular to the first direction.

In accordance with yet another feature of the invention, the radiation transmittant portion has an annular shape, the transmitted intensity of electromagnetic radiation being constant within the radiation transmittant portion.

Embodiments of the present invention further provide a photolithography apparatus including a substrate to be patterned and a reticle. The reticle has a plurality of patterns to be transferred onto the substrate. The reticle includes at least one pattern extending in a first direction and having a pattern size dx, an illumination system as defined above and, an optical projection system for projecting an image of the reticle onto the substrate, the optical projection system having a numerical aperture (NA).

For example, the radius rₒᵤₜ of the second opaque portion may be determined in dependence from the pattern size dx of the reticle and the numerical aperture of the optical projection system so that for the ±1^{st} diffraction order part of the light due to illumination with the radiation transmittant portion lies outside the numerical aperture of the optical projection system. Accordingly, the parameters of the device for generating an illumination distribution are set in accordance with the lithography apparatus and the pattern to be transferred onto the substrate. To be more specific, the parameters pattern size dx and numerical aperture of the optical projection system are fixed. The parameters of the device for generating an illumination distribution are chosen in correspondence with these parameters so that for the ±1^{st} diffraction order part of the light due to illumination with the radiation transmittant portion lies outside the numerical aperture of the optical projection system.

By way of example, the radius rₒᵤₜ of the second opaque portion may be determined in dependence from the pattern size dx of the reticle and the numerical aperture of the optical projection system so that, for the +1^{st} diffraction order, the light due to illumination with the first pole lies outside the numerical aperture of the optical projection system and for the −1^{st} diffraction order the light due to illumination with the second pole lies outside the numerical aperture of the optical projection system. As a result, it becomes possible to transfer a lines/spaces pattern having an orientation in the x direction as well as a lines/spaces pattern having an orientation in the y direction with a high contrast onto a substrate to be patterned.

In addition, the radius rₒᵤₜ of the second opaque portion can be determined in dependence from the pattern size dx of the reticle and the numerical aperture of the optical projection system so that, for the +1^{st} diffraction order, the light due to illumination with the third pole lies outside the numerical aperture of the optical projection system and, for the −1^{st} diffraction order, the light due to illumination with the fourth pole lies outside the numerical aperture of the optical projection system.

In accordance with again a further feature of the invention, the reticle has a further pattern extending in a second direction perpendicular to the first direction and having a pattern size dx, a radius r_{out,y} of the second opaque portion, which is a radius r_{out,y} extending in the first direction, is determined dependent upon the pattern size dy of the reticle and the numerical aperture of the optical projection system, and a radius r_{out,x} of the second opaque portion, which is a radius r_{out,x} extending in the second direction, is determined dependent upon the pattern size dx of the reticle and the numerical aperture of the optical projection system so that for the ±1^{st} diffraction order part of the light due to illumination with the radiation transmittant portion lies outside the numerical aperture of the optical projection system.

The photolithography apparatus includes a reticle that can, in particular, be an alternating phase shifting mask (AltPSM) or any other photomask where the pattern is generated by interference of the ±1^{st} diffraction orders of the imaging radiation.

The device of generating an illumination distribution includes an appropriate aperture element, a diffractive element or a suitable system of lenses or a suitable combination of these elements.

With the objects of the invention in view, there is also provided an illumination system suitable for use in a photolithography apparatus, the illumination system including an illumination source emitting electromagnetic radiation, an illumination distribution generating device for generating an illumination distribution with a center point and an outer edge, the illumination distribution having a first opaque portion defined about the center point, each point of the first opaque portion having a distance from the center point smaller than a radius rᵢₙ, a second opaque portion defined adjacent the outer edge, the second opaque portion having a distance from the center point larger than a radius rₒᵤₜ, and a radiation transmittant portion disposed between the first and second opaque portions, a polarization device configured to generate linearly polarized electromagnetic radiation having a locally varying polarization direction so that at least first and second polarization directions are generated, the first polarization direction being different from the second polarization direction. In one embodiment, sections of the radiation transmittant portion are polarized in a parallel manner, wherein, in the radiation transmittant portion at least two points that are disposed along a direction perpendicular to the first polarization direction are assigned to a polarization along the first polarization direction. In another embodiment, sections of the radiation transmittant portion are polarized in a radial manner, wherein, in the radiation transmittant portion (36), each point is assigned to a polarization parallel to a line connecting the respective point and the center point. In an embodiment, a radius r_{in,y} measured in a first direction is different from a radius r_{in,x} measured in a second direction perpendicular to the first direction. In an embodiment, a radius r_{out,y} measured in a first direction is different from a radius r_{out,x} measured in a second direction perpendicular to the first direction.

With the objects of the invention in view, there is also provided an illumination system suitable for use in a photolithography apparatus, the illumination system including an illumination source emitting electromagnetic radiation, an illumination distribution generating device for generating an illumination distribution with a center point and an outer edge, the illumination distribution having a first opaque portion defined about the center point, each point of the first opaque portion having a distance from the center point smaller than a radius rᵢₙ, a second opaque portion defined adjacent the outer edge, the second opaque portion having a distance from the center point larger than a radius rₒᵤₜ, and a radiation transmittant portion disposed between the first and second opaque portions, the radiation transmittant portion having first, second, third and fourth poles, an intensity of transmitted radiation in each of the poles being larger than in another part of the radiation transmittant portion, at least one of the poles having an elliptical shape, and a polarization device configured to generate linearly polarized electromagnetic radiation having a locally varying polarization direction so that at least first and second polarization directions are generated, the first polarization direction being different from the second polarization direction.

In accordance with a concomitant feature of the invention, the first and second poles are disposed along a first direction, the third and fourth poles are disposed along a second direction perpendicular to the first direction, the polarization direction of the electromagnetic radiation being transmitted by the first and second poles is parallel to the first direction, and the polarization direction of the electromagnetic radiation being transmitted by the third and fourth poles is parallel to the second direction.

Other features that are considered as characteristic for the invention are set forth in the appended claims.

Although the invention is illustrated and described herein as embodied in an illumination system and a photolithography apparatus, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

In the following, embodiments of the invention will be described in greater detail with reference to the accompanying drawings.

FIG. 1 is a diagrammatic, exploded perspective view of a photolithography apparatus;

FIG. 2 is a diagrammatic illustration of an exemplary conventional imaging with off-axis illumination;

FIG. 3 is a diagrammatic illustration of an exemplary imaging of a pattern with an AltPSM mask;

FIG. 4 is a diagrammatic illustration of an exemplary conventional aperture element for implementing on-axis illumination;

FIG. 5 is a diagrammatic block diagram of a photolithography apparatus according to an exemplary embodiment of the present invention;

FIG. 6 is a plan view of an illumination distribution generated by the illumination system of an exemplary embodiment of the present invention;

FIG. 7 is a plan view of another illumination distribution generated by the illumination system of an exemplary embodiment of the present invention;

FIG. 8 is a plan view of a further illumination distribution generated by the illumination system of an exemplary embodiment of the present invention;

FIG. 9A is a plan view of yet another illumination distribution generated by the illumination system of an exemplary embodiment of the present invention;

FIG. 9B is a plan view of still a further illumination distribution generated by the illumination system of an exemplary embodiment of the present invention;

FIG. 10 is a plan view of exemplary positions of diffracted light beams in the plane of the entrance pupil of an optical projection system according to the present invention;

FIG. 11 is a plan view of yet a further illumination distribution generated by the illumination system of an exemplary embodiment of the present invention; and

FIG. 12 is a plan view of further exemplary positions of diffracted light beams in the plane of the entrance pupil of the optical projection system according to the present invention.

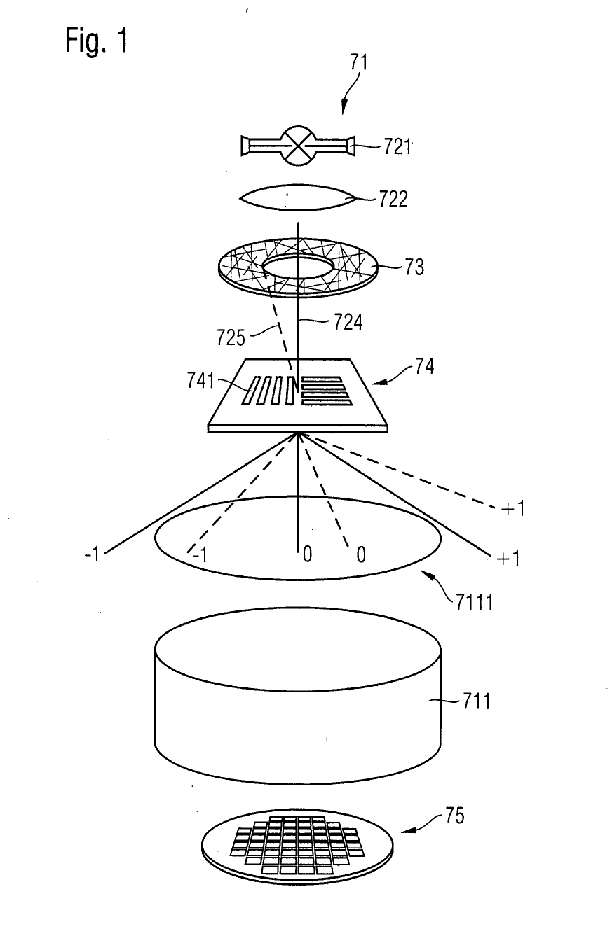

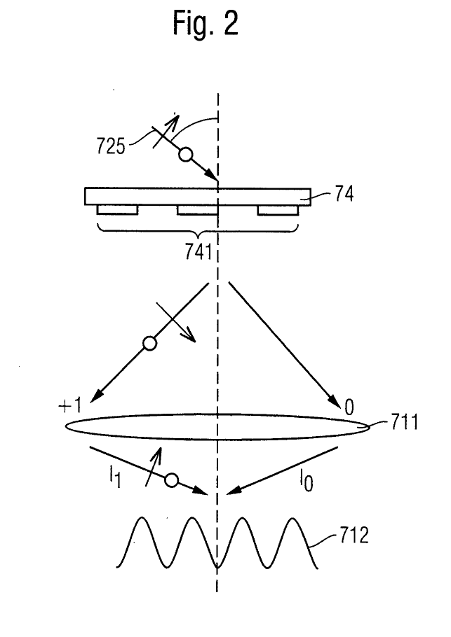

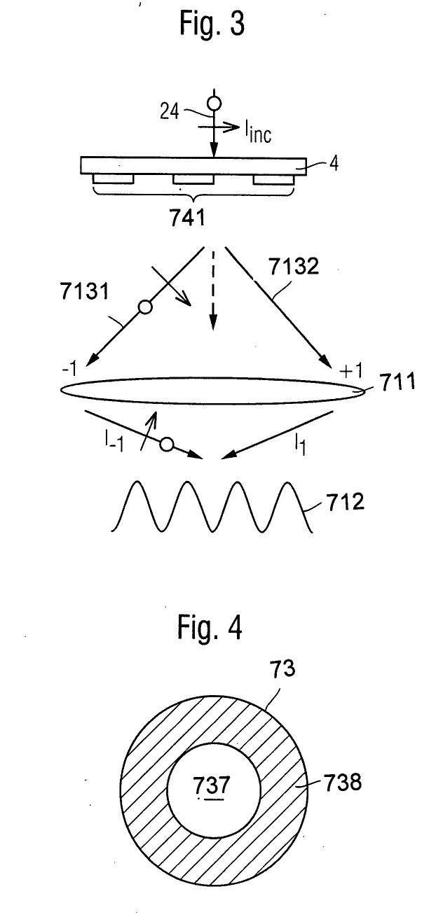

### DESCRIPTION OF THE PREFERRED EMBODIMENT

In the following, the invention will be described in more detail by exemplary embodiments and the corresponding figures. By schematic illustrations that are not true to scale, the figures show different exemplary embodiments of the invention.

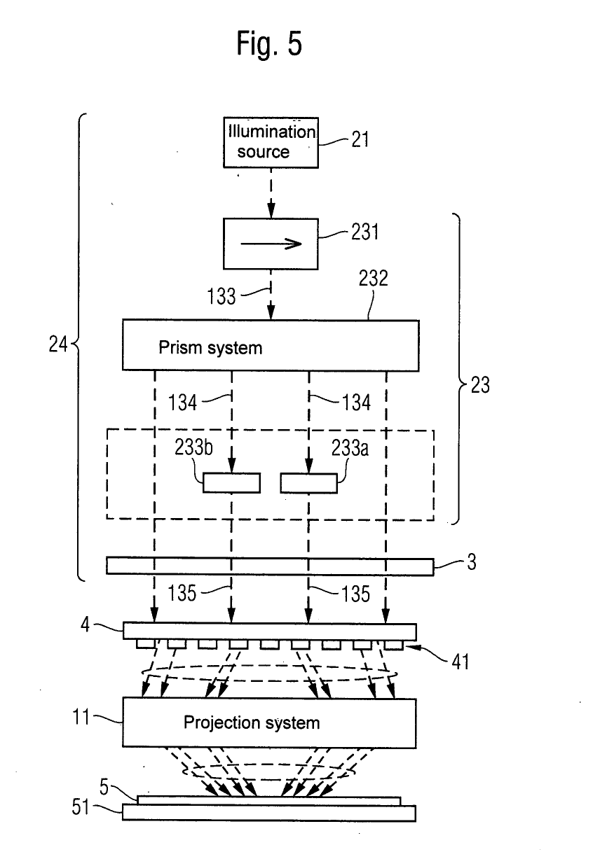

Referring now to the figures of the drawings in detail and first, particularly to FIG. 5 thereof, there is shown an exemplary photolithographic apparatus according to an embodiment of the present invention. The photolithographic apparatus includes an illumination system 24 that has an illumination source 21. The illumination source can be any light source or other device or combination of devices that are capable of generating light used to create a photolithographic image. As used throughout this disclosure, the term “light” refers to electromagnetic radiation in the visible light spectrum as well as the invisible spectrum, including without limitation visible light, ultraviolet light, and X-rays. For example, the illumination source 21 may include a laser such as an argon fluoride laser, a fluorine excimer laser, or a helium neon laser. The illumination system 24 further includes a polarization device 23 and a device for generating an illumination distribution 3. The polarization device may be disposed between the illumination source 21 and the illumination distribution generating device 3. The polarization device may be adapted to generate linearly polarized electromagnetic radiation having a locally varying polarization direction as will be described hereinafter. In particular, an exemplary structure of the polarization device 23 will be described after the description of an illumination distribution generated by the device for generating an illumination distribution 3.

The pattern 41 of the reticle 4 may be transferred from the reticle 4 to a wafer 5 by irradiating the reticle with the illumination distribution generated by the illumination system 24. For example, the pattern 4 may be imaged onto the wafer by the projection system 11. The reticle 4 usually may be held by a stage (not shown). Moreover, the wafer 5 may be held by a wafer stage 51.

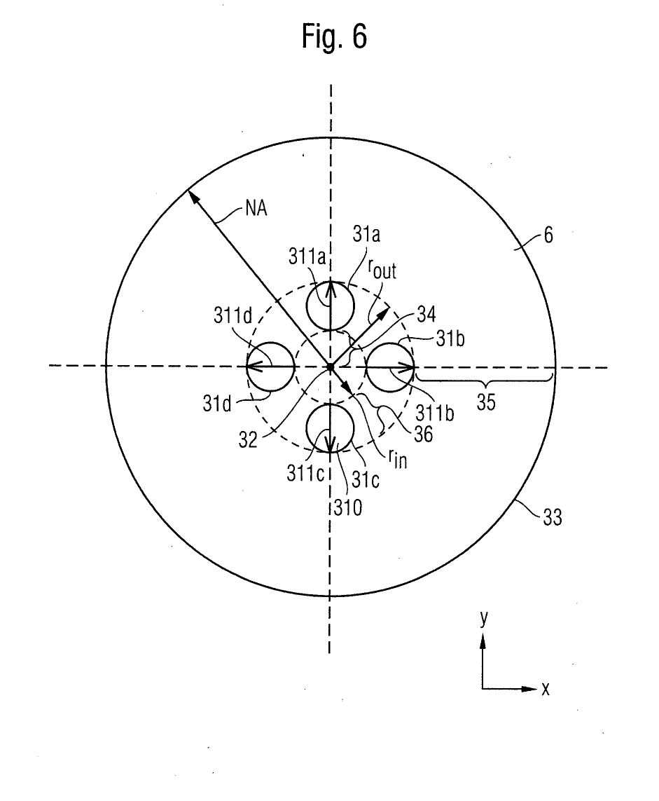

As is shown in FIG. 6 illustrating an illumination distribution generated by the illumination system according to an embodiment of the present invention, the illumination distribution has a center point 32 at the center thereof. The first opaque region is defined about the center point 32, and a second opaque portion is defined adjacent to the outer edge. Each point located in the first opaque portion 34 has a distance from the center point 32 that is smaller than rᵢₙ. Each point in the second opaque portion 35 has a distance from the center point 32 that is larger than rₒᵤₜ. As is shown in FIG. 6, the first opaque portion 34 may have a circular shape around the center point 32. Nevertheless, as is to be understood, the first opaque portion can, as well, have a shape that deviates from circular. In particular, the first opaque portion may have an elliptical shape.

The illumination distribution 6 further includes a light transmittant portion 36, which is located between the first and the second opaque portions 34, 35. The light transmittant portion 36 is a portion having regions with a high light intensity. For example, the transmittant portion 36 may be entirely illuminated or it may include a predetermined number of, for example, four illumination poles 31a, 31b, 31c and 31d. Nevertheless, as is clearly to be understood any other number of poles may be used. For example, 6 or 8 poles may be used as well. The polarization device is adapted to provide a locally varying polarization direction of the light. For example, as is indicated by the arrows in the poles 31a to 31d, the polarization direction in each of the poles may be parallel to a direction connecting the center point of the poles with the center point 32 of the illumination distribution 6. For example, as is shown in FIG. 6, the polarization direction of the poles 31a, 31c may be along the y-direction, whereas the polarization direction of the poles 31b, 31d may be along the x-direction.

Likewise, the illumination distribution 6 shown in FIG. 6 could as well have 8 poles, where the polarization direction of light transmitted by the pole that is disposed between the poles 31a, 31b is rotated by 45° with respect to the y-direction and the light transmitted by the pole that is disposed between the poles 31b, 31c is rotated by 45° with respect to the x-direction. Alternatively, the illumination distribution 6 may have 8 poles, where the polarization direction of light transmitted by the pole which is disposed between the poles 31a, 31b is parallel to the y- or x-direction.

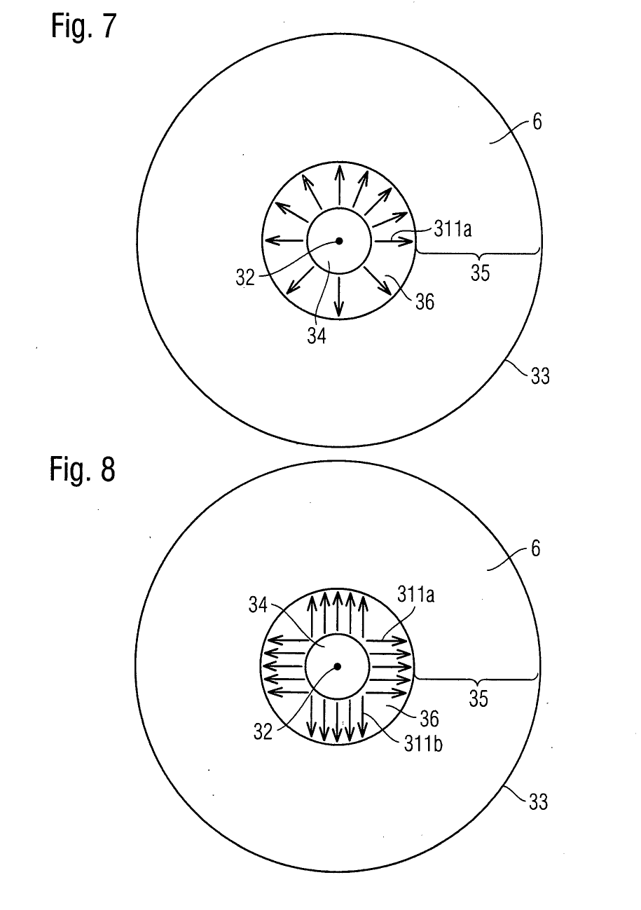

FIGS. 7 and 8 illustrate a further embodiment of the present invention, where the light transmittant portion 36 of the illumination distribution 6 has an annular shape. As can be seen, the polarization direction of the light transmittant portion 36 can have a radial direction, i.e., the polarization direction at each point of the annular ring around the center point 32 has a direction parallel to a direction of this point connected with the center point 32. Such a distribution of the polarization directions can be simplified, as is shown in FIG. 8. For example, in a specific range of angles between the outer edge 33 of the illumination distribution 6 and the center point 32, the polarization direction is along the y-direction, whereas, in another angular range between the outer edge 33 and the center point 32 with respect to the x-direction, the polarization direction is along the x-direction. The angular ranges for the polarization direction along the y-direction and the x-direction can be arbitrarily chosen dependent upon the system requirements.

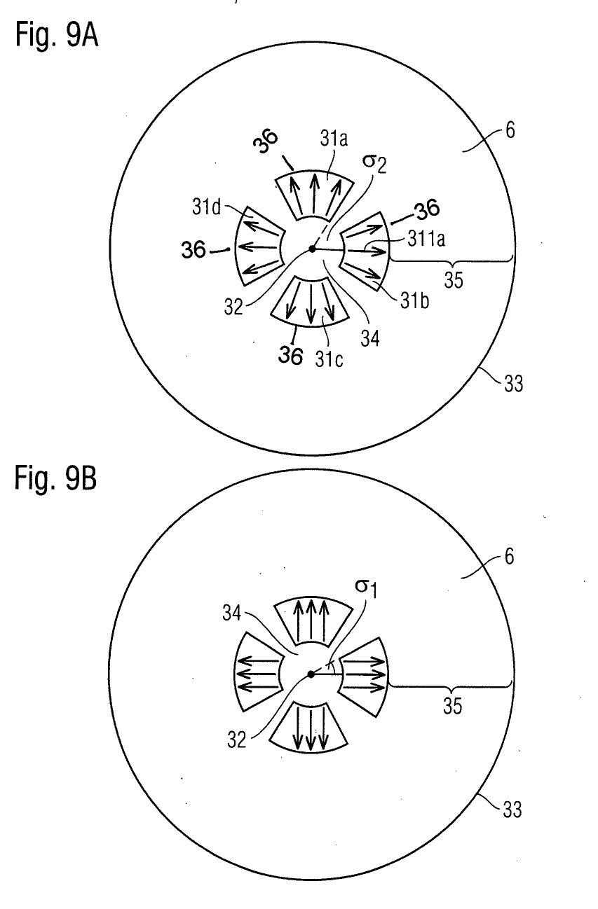

According to a further embodiment of the present invention, as is shown in FIGS. 9A and 9B, the light transmittant portion 36 of the illumination distribution 6 may include segments of a ring. In particular, the four illumination poles 31a, 31b, 31c, and 31d are not circular or elliptical but have the shape of a segment of a ring. As is shown in FIG. 9A, the polarization direction of each of the poles may have a radial direction, i.e., the polarization direction at each point of a pole has a direction parallel to a direction of this point connected with the center point 32. This distribution of the polarization directions may be simplified, as is shown in FIG. 9B. For example, in a similar manner as in FIG. 6, the poles 31a, 31c may have a polarization direction that is parallel to the y-direction, whereas the poles 31b, 31d have a polarization direction that is parallel to the x-direction. The angles σ₁ and σ₂ may be arbitrarily chosen in accordance with the system requirements.

The locally varying polarization direction of the incident light beam may be accomplished in different manners. For example, as is indicated in FIG. 5, the polarization device may include a polarizer 231 for generating linearly polarized light 133. As is clearly to be understood, the polarizer 231 can be formed integrally with the light source 21, although it is illustrated as a distinct device in FIG. 5. The polarization device 23 may further include a prism system 232. The prism system 232 may be adapted to divide the linearly polarized light beam 133 into one or more light beams that are locally separated from one another. The polarization device 23 may further include two polarization rotating elements 233a, 233b, which may rotate the polarization direction of the incident light beams by 90°. In a similar manner, further prisms may be provided to obtain more divided light beams. In addition, the polarization direction may be rotated by any desired angle by providing a suitable polarization rotating elements 233a, 233b. As a further alternative, the polarization device 23 may be formed integrally with the aperture element 3, for example, as a so-called wire grid polarizer, including a grid in a predetermined direction.

The orientation of the wire grid polarizer is selected so that the polarization direction is achieved for the transmittant portion of the aperture element 3 as has been described above.

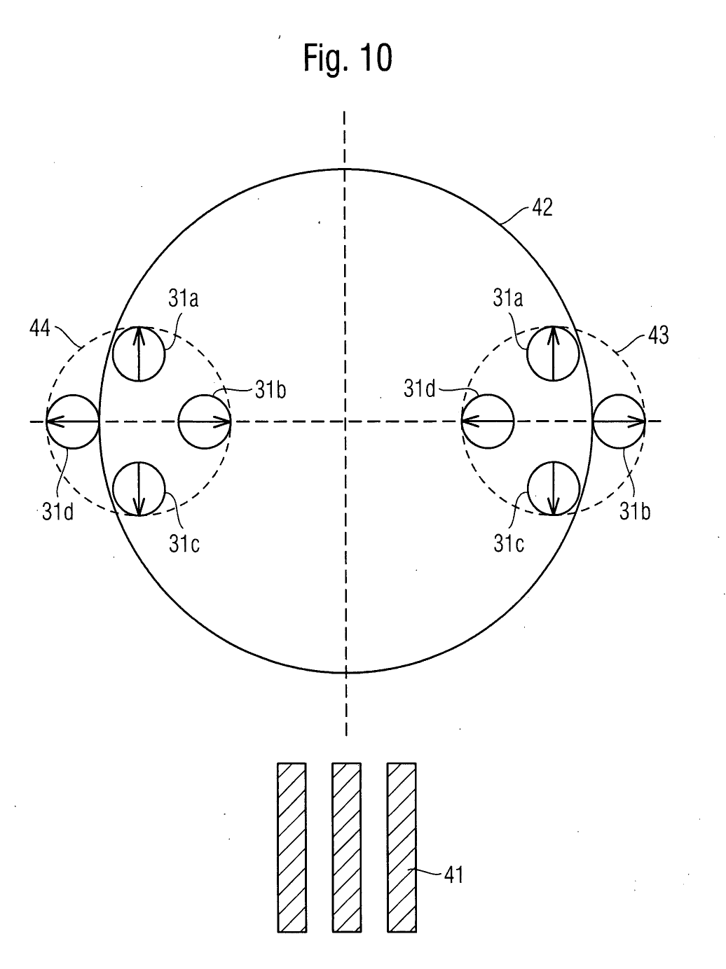

The central portion of FIG. 10 shows the positions of the +1^{st} and −1^{st} diffracted beams in the entrance pupil of the projection system 11 when using the illumination distribution shown in FIG. 7 and the pattern 41 on the reticle 4 as indicated in the lower portion of FIG. 10. In particular, FIG. 10 illustrates the positions of the poles 31a, 31b, 31c, 31d when being diffracted by the pattern 41. According to an embodiment of the present invention, a special effect is obtained if the geometrical dimensions of the device 3 for generating an illumination distribution are determined dependent upon the pitch of the pattern 41 as well as the numerical aperture (NA) of the projection system 11 for imaging the pattern onto the substrate 5. As can be seen in FIG. 10, the size of the light transmittant portion of the illumination distribution 6 may be selected, so that the pole 31b is cut off the +1^{st} diffraction order and the pole 31d is cut off the −1^{st} diffraction order. As a consequence, when imaging the pattern 41 from the photomask onto the substrate, the TM polarized radiation may be decreased, resulting in a decreased amount of interference. Because the poles 31a, 31c are maintained within the entrance pupil 111, these portions may interfere with each other, resulting in an increased contrast.

In FIG. 10, the position of the +1^{st} and −1^{st} diffraction order depends on the pattern size dx of the pattern to be transferred. Accordingly, the smaller the pattern, the smaller the value of rᵢₙ.

For imaging a horizontal pattern 41, which is rotated by 90° with respect to the pattern shown in FIG. 10, the same applies. More specifically, if the diffraction grating is rotated by 90°, the +1^{st} and −1^{st} diffraction orders are located above and below the center point shown in FIG. 10. In such a case, the pole 31a may be cut off the +1^{st} diffraction order, whereas the pole 31c may be cut off the −1^{st} diffraction order. In any case, the rim of the pupil is such that one pole including light having a polarization direction that will cause destructive interference with respect to the pattern to the image is cut off from the entrance pupil 111 of the projection system 11. Differently stated, the diffracted beam of the +1^{st} order due to illumination with pole 31b is not captured by the pupil. Likewise, the diffracted beam of the −1^{st} order due to illumination with pole 31d may not be captured by the pupil. As a consequence, the contrast of the image may be remarkably increased. Hence, the image quality may be improved.

When imaging a pattern including a horizontal lines/spaces pattern as well as a vertical lines/spaces pattern, the +1^{st} and −1^{st} diffraction orders are located on the x-axis as well as on the y-axis of the system. If, in addition, the vertical pattern size dx is different from the horizontal pattern size dy, the poles on the x-axis have a size that may be different from the size of the poles on the y-axis. In other words, in such a case, the first and the second poles have a diameter that may be different from the diameter of the third and fourth poles.

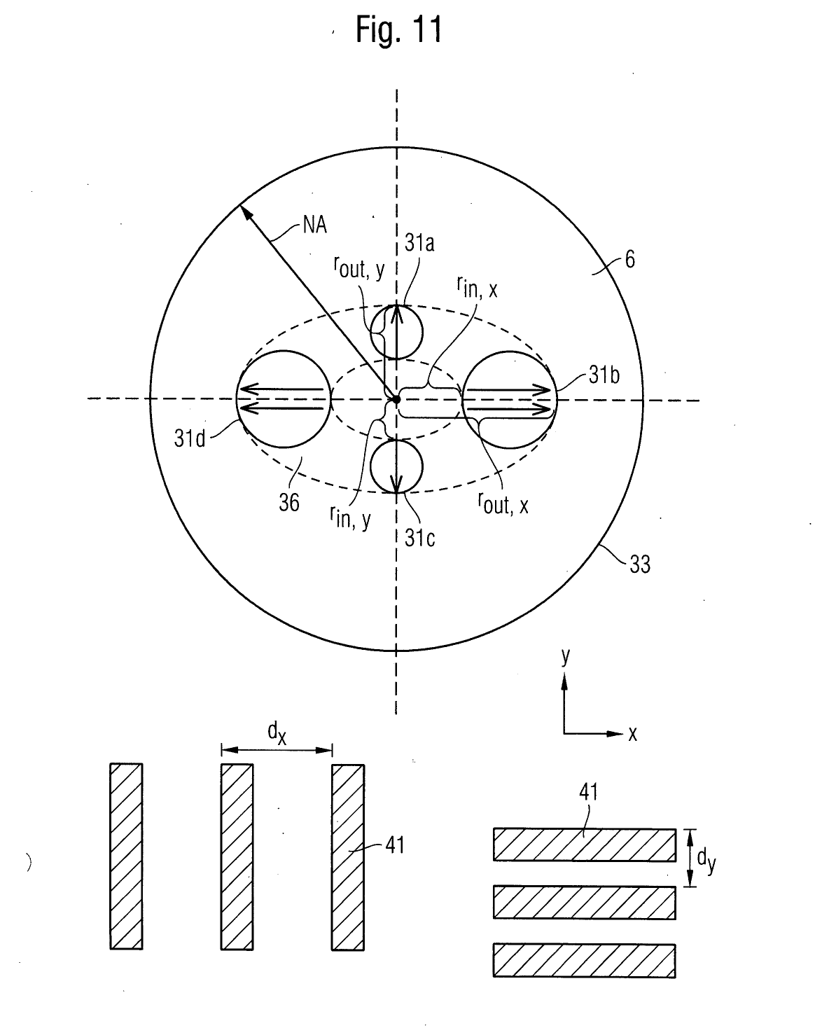

FIG. 11 shows an exemplary illumination distribution in a case in which a first pattern extending in the x-direction (having a pattern size dx) and a second pattern extending in the y-direction (the second pattern having pattern size dy) are to be images. As is shown in the lower portion of FIG. 11, the pattern size dy of the pattern extending in the y-direction is smaller than the pattern size dx of the pattern extending in the x-direction. In this embodiment, the light transmittant portion 36 has an annular elliptical shape, wherein the outer radius r_{out,x} which is measured in the x-direction may be larger than the outer radius r_{out,y} which is measured in the y-direction. Moreover, the inner radius r_{in,x} which is measured in the x-direction is larger than the inner radius r_{in,y} which is measured in the y-direction. As is clearly to be understood, in this case, the light transmittant portion 36 may include illumination poles having an arbitrary shape. In particular, the poles may have a circular or an elliptical shape, or they may form segments of a ring. Alternatively, the light transmittant portion 36 may have an annular shape.

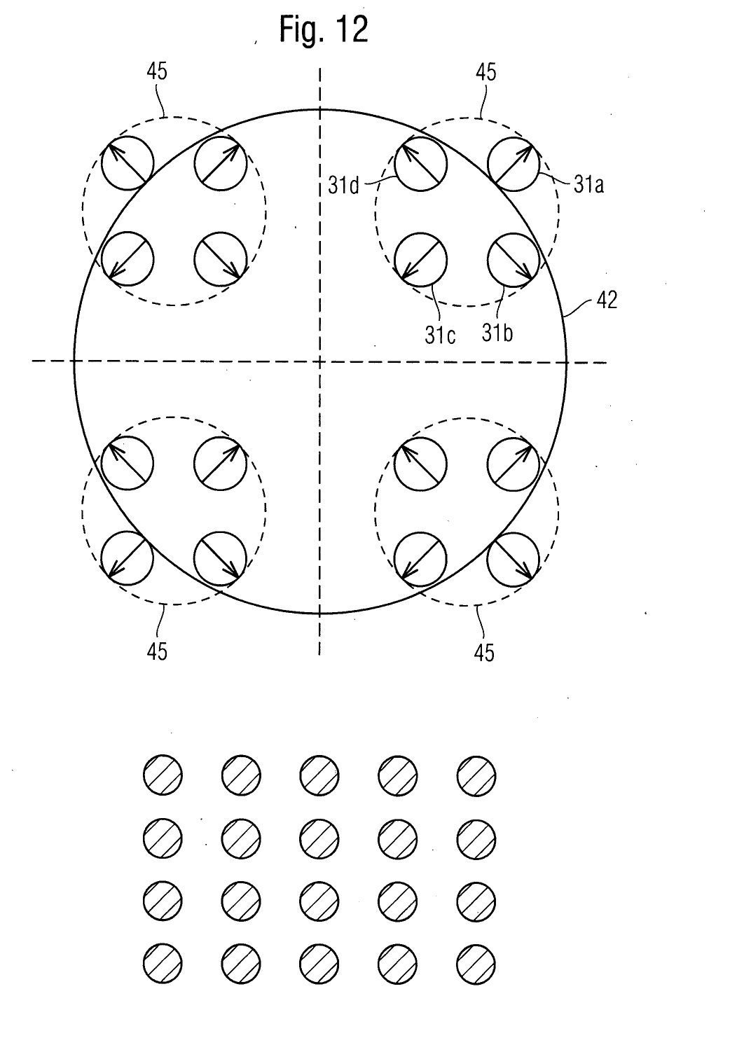

The photolithography apparatus is not only restricted to a lines/spaces pattern. It can be similarly applied to any other kind of patterns. For example, if a contact hole pattern is to be transferred, a similar illumination scheme may be used. FIG. 12 shows the ±1^{st} diffraction orders in this case. As is shown in FIG. 12, in this case, the diffracted beams due to an illumination distribution 6 that is shown in FIG. 6 may be disposed on the diagonals of the system. In this case, again, the dimensions of the illumination distribution are selected so that one pole of the diffraction image will be removed from the pupil 111. In the case of a contact hole pattern illustrated in the lower portion of FIG. 12, light transmitted by the outermost poles of the illumination distribution, the light having a polarization direction that is rotated by 45° with respect to the X— or Y-direction, would be destructive. Accordingly, the device for generating an illumination distribution that forms part of the illumination system of the present invention can be used in this case as well. As a consequence, the light being transmitted by the outermost poles is cut off the pupil of the projection system 11 so that finally the pattern having an improved contrast is transferred onto the wafer.

We claim:

1. A photolithography apparatus, comprising:
a reticle including at least one pattern extending in a first direction and having a pattern size dy;
an optical projection system for projecting an image of the reticle onto a substrate to be patterned, said optical projection system having a numerical aperture; and
an illumination system having:
an illumination source emitting electromagnetic radiation;
an illumination distribution generating device for generating an illumination distribution with a center point and an outer edge, said illumination distribution having:
a first opaque portion defined about said center point, each point of said first opaque portion having a distance from said center point smaller than a radius rᵢₙ;
a second opaque portion defined adjacent said outer edge, said second opaque portion having a distance from said center point larger than a radius rout; and
a radiation transmittant portion disposed between said first and second opaque portions;
a polarization device being configured to generate linearly polarized electromagnetic radiation having a locally varying polarization direction so that at least first and second polarization directions are generated, said first polarization direction being different from said second polarization direction, said radius rₒᵤₜ of said second opaque portion is determined dependent upon said pattern size dy and said numerical aperture so that for a ±1^{st} diffraction order part of light due to illumination with said radiation transmittant portion lies outside said numerical aperture.

2. The photolithography apparatus according to claim 1, wherein sections of said radiation transmittant portion are parallel polarized such that, in said radiation transmittant portion, at least two points that are disposed along a direction perpendicular to said first polarization direction are polarized along said first polarization direction.

3. The photolithography apparatus according to claim 1, wherein sections of said radiation transmittant portion are radial polarized such that, in said radiation transmittant portion, each point is associated with a polarization parallel to a line connecting said respective point and said center point.

4. The photolithography apparatus according to claim 1, wherein:
said radiation transmittant portion has first, second, third and fourth poles;
said first and second poles are disposed along a first direction;
said third and fourth poles are disposed along a second direction perpendicular to said first direction;
an intensity of transmitted radiation in each of said poles is larger than in another part of said radiation transmittant portion;
said polarization direction of said electromagnetic radiation being transmitted by said first and second poles is parallel to said first direction; and
said polarization direction of said electromagnetic radiation being transmitted by said third and fourth poles is parallel to said second direction.

5. The photolithography apparatus according to claim 4, wherein each of said poles has a circular shape.

6. The photolithography apparatus according to claim 4, wherein at least one of said poles has an elliptical shape.

7. The photolithography apparatus according to claim 4, wherein at least one of said poles has a shape of a segment of a ring.

8. The photolithography apparatus according to claim 5, wherein a diameter of each of said first, second, third, and fourth poles is equal to a difference between rₒᵤₜ and rᵢₙ.

9. The photolithography apparatus according to claim 1, wherein said radius rᵢₙ is constant.

10. The photolithography apparatus according to claim 1, wherein said radius rₒᵤₜ is constant.

11. The photolithography apparatus according to claim 1, wherein a radius r_{in,y} measured in said first direction is different from a radius r_{in,x} measured in a second direction perpendicular to said first direction.

12. The photolithography apparatus according to claim 1, wherein a radius r_{out,y} measured in said first direction is different from a radius r_{out,x} measured in a second direction perpendicular to said first direction.

13. The photolithography apparatus according to claim 1, wherein the radiation transmittant portion has an annular shape, the transmitted intensity of electromagnetic radiation being constant within the radiation transmittant portion.

14. The photolithography apparatus according to claim 4, wherein said radius rₒᵤₜ of said second opaque portion is determined dependent upon said pattern size dy of said reticle and said numerical aperture of said optical projection system so that, for a +1^{st} diffraction order, light due to illumination with said first pole lies outside said numerical aperture of said optical projection system and, for a −1^{st} diffraction order, light due to illumination with said second pole lies outside said numerical aperture of said optical projection system.

15. The photolithography apparatus according to claim 4, wherein said radius rₒᵤₜ of said second opaque portion is determined dependent upon said pattern size dy of said reticle and said numerical aperture of said optical projection system so that, for a +1^{st} diffraction order, light due to illumination with said third pole lies outside said numerical aperture of said optical projection system and, for said −1^{st} diffraction order, light due to illumination with said fourth pole lies outside said numerical aperture of said optical projection system.

16. The photolithography apparatus according to claim 1, wherein:
said reticle comprises a further pattern extending in a second direction perpendicular to said first direction and having a pattern size dx;
a radius r_{out,y} of said second opaque portion, which is a radius r_{out,y} extending in said first direction, is determined dependent upon said pattern size dy of said reticle and said numerical aperture of said optical projection system; and
a radius r_{out,x} of said second opaque portion, which is a radius r_{out,x} extending in said second direction, is determined dependent upon said pattern size dx of said reticle and said numerical aperture of said optical projection system so that for said ±1^{st} diffraction order part of said light due to illumination with said radiation transmittant portion lies outside said numerical aperture of said optical projection system.

17. An illumination system suitable for use in a photolithography apparatus, the illumination system comprising:
an illumination source emitting electromagnetic radiation;
an illumination distribution generating device for generating an illumination distribution with a center point and an outer edge, said illumination distribution having:
a first opaque portion defined about said center point, each point of said first opaque portion having a distance from said center point smaller than a radius rᵢₙ;
a second opaque portion defined adjacent said outer edge, said second opaque portion having a distance from the center point larger than a radius rₒᵤₜ; and
a radiation transmittant portion disposed between said first and second opaque portions; and
a polarization device configured to generate linearly polarized electromagnetic radiation having a locally varying polarization direction so that at least first and second polarization directions are generated, said first polarization direction being different from said second polarization direction.

18. The photolithography apparatus according to claim 17, wherein sections of said radiation transmittant portion are parallel polarized such that, in said radiation transmittant portion, at least two points that are disposed along a direction perpendicular to said first polarization direction are polarized along said first polarization direction.

19. The photolithography apparatus according to claim 17, wherein sections of said radiation transmittant portion are radial polarized such that, in said radiation transmittant portion, each point is associated with a polarization parallel to a line connecting said respective point and said center point.

20. The illumination system according to claim 17, wherein a radius r_{in,y} measured in a first direction is different from a radius r_{in,x} measured in a second direction perpendicular to said first direction.

21. The illumination system according to claim 17, wherein a radius r_{out,y} measured in a first direction is different from a radius r_{out,x} measured in a second direction perpendicular to said first direction.

22. An illumination system suitable for use in a photolithography apparatus, the illumination system comprising:
an illumination source emitting electromagnetic radiation;
an illumination distribution generating device for generating an illumination distribution with a center point and an outer edge, said illumination distribution having:
a first opaque portion defined about said center point, each point of said first opaque portion having a distance from said center point smaller than a radius rᵢₙ;
a second opaque portion defined adjacent said outer edge, said second opaque portion having a distance from said center point larger than a radius rₒᵤₜ; and
a radiation transmittant portion disposed between said first and second opaque portions, said radiation transmittant portion having first, second, third and fourth poles, an intensity of transmitted radiation in each of said poles being larger than in another part of said radiation transmittant portion, at least one of said poles having an elliptical shape; and
a polarization device configured to generate linearly polarized electromagnetic radiation having a locally varying polarization direction so that at least first and second polarization directions are generated, said first polarization direction being different from said second polarization direction.

23. The illumination system according to claim 22, wherein:
said first and second poles are disposed along a first direction
said third and fourth poles are disposed along a second direction perpendicular to said first direction;
said polarization direction of said electromagnetic radiation being transmitted by said first and second poles is parallel to said first direction; and
said polarization direction of said electromagnetic radiation being transmitted by said third and fourth poles is parallel to said second direction.
